(19) United States
(12) Patent Application Publication
(10) Pub. No.: US 2010/0100372 A1
(43) Pub. Date: Apr. 22, 2010

(54) STEREO ENCODING DEVICE, STEREO DECODING DEVICE, AND THEIR METHOD

(75) Inventors: Jiong Zhou, Singapore (SG); Kok Seng Chong, Singapore (SG)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/524,453

(22) PCT Filed: Jan. 25, 2008
(86) PCT No.: PCT/JP2008/051035

§ 371 Date: Aug. 25, 2009

(30) Foreign Application Priority Data
Jan. 26, 2007 (JP) 2007-016550

(51) Int. Cl. G10L 19/00; G10L 21/04

(52) U.S. Cl. 704/201; 704/503

(57) ABSTRACT

Disclosed is a stereo encoding device which can improve critical channel encoding accuracy without increasing the encoding information amount. The device includes: a monaural signal synthesis unit (101) which combines a left channel signal L(n) and a right channel signal R(n) so as to generate a monaural signal M(n); a correlation coefficient calculation unit (102) which calculates a correlation coefficient CML between M(n) and L(n) and a correlation coefficient CMR between M(n) and R(n); a critical channel judging unit (103) which decides one of the L(n) and R(n) having a smaller correlation with M(n) as the critical channel if the ratio of CML against CMR is not within a predetermined range from 90% to 111%, for example; and an ICP encoding unit (104) which performs ICP encoding by adjusting the degree of the ICP parameter of the critical channel to be higher than the degree of the ICP parameter of the non-critical channel.

### TECHNICAL FIELD

The present invention relates to a stereo encoding apparatus, stereo decoding apparatus and stereo encoding and decoding methods that are used to encode or decode stereo speech signals and stereo audio signals in mobile communication systems or in packet communication systems using the Internet protocol (“IP”).

### BACKGROUND ART

In mobile communication systems or packet communication systems using IP, the restriction of the digital signal processing speed in DSP (Digital Signal Processor) and the restriction of bandwidth are gradually relaxed. If a transmission bit rate becomes higher, a band for transmitting a plurality of channels can be ensured, so that communication using the stereo scheme (i.e. stereo communication) is expected to become popular even in speech communication where the monaural scheme is a mainstream.

Current mobile telephones have already mounted a multimedia player and FM radio function which provide stereo function. Therefore, it naturally follows that the fourth generation mobile phones and IP phones has additional functions of recording and playing stereo speech signals in addition to stereo audio signals.

Up till now, ISC (Intensity Stereo Coding), BCC (Binaural Cue Coding), ICP (Inter-Channel Prediction), and so on, are used as a method of encoding a stereo signal. Non-Patent Document 1 discloses a technique of predicting and estimating a stereo signal based on a monaural codec, using those coding methods. To be more specific, a monaural signal is acquired by synthesis using channel signals forming a stereo signal such as the left channel signal and the right channel signal, the resulting monaural signal is encoded/decoded using a known speech codec, and, furthermore, the difference signal (i.e. side signal) between the left channel and the right channel is predicted/estimated from the monaural signal using prediction parameters. In such a coding method, the encoding side models the relationship between the monaural signal and the side signal using time-dependent adaptive filters, and transmits filter coefficients calculated per frame, to the decoding side. The decoding side reconstructs the difference signal by filtering the monaural signal of high quality transmitted by the monaural codec, and calculates the left channel signal and the right channel signal from the reconstructed difference signal and the monaural signal.

Further, Non-Patent Document 2 discloses an encoding method called “cross-channel correlation canceller,” and, when the technique using a cross-channel correlation canceller is applied to the encoding method of the ICP scheme, it is possible to predict one channel from the other channel.

The prediction gain shown in following equation 1 is an index to designate the prediction performance of the ICP scheme disclosed in above-described Non-Patent Document 1 and Non-Patent Document 2.

$$\begin{matrix}( Equation 1 ) & \\ Gain = 10 {log}_{10} \frac{\sum {y}^{2} ( n )}{\sum {e}^{2} ( n )} & [ 1 ]\end{matrix}$$

In this equation, y(n) is the reference signal, and e(n) is the prediction error expressed by e(n)=y(n)−y′(n). Here, y′(n) represents the prediction signal, and n represents the index of samples of signals in the time domain. When the prediction gain “Gain” increases, the performance of the ICP scheme is better.

Further, in stereo encoding of the ICP scheme, the unique inter-channel correlation is used as information for use in predicting/estimating the left channel signal and the right channel signal. Such stereo encoding of the ICP scheme is suitable for signals in which the energy is concentrated in the lower frequency band, such as a speech signal.
Non-Patent Document 1: 3GPP TS26.290 V6.3.0, June 2005
Non-Patent Document 2: S. Minami and O. Okada, “Stereophonic ADPCM voice coding method”, in Proc. IEEE Int. Conf. Acoust., Speech, Signal Processing (ICASSP'90), Albuquerque, N. Mex., April 1990, pp. 1113-1116

### DISCLOSURE OF INVENTION

### Problems to be Solved by the Invention

There is no dependent relationship between the right and left channels of a stereo signal. Consequently, in stereo encoding of the ICP scheme, it is possible to improve the prediction performance between channels by adopting a configuration for directly predicting the left channel and the right channel using a monaural signal acquired by adding the left channel signal and the right channel signal.

In the stereo encoding of the ICP scheme disclosed in Non-Patent Document 1 and Non-Patent Document 2, the order of the prediction parameters (i.e. adaptive filter coefficients) is a constant. However, when the correlation level between two channels is lower, the order of the adaptive filter required for prediction increases. Therefore, when the correlation level between two channels is equal to or lower than a predetermined value, for example, when the left channel signal L(n) of a stereo signal is much higher than the right channel signal R(n) of the stereo signal, the order of the adaptive filter required to achieve predetermined prediction performance becomes enormous and makes the prediction extremely difficult. That is, in the case of L(n)>>R(n), the monaural signal M(n) shown in following equation 2 is substantially the same as L(n)/2.

$$\begin{matrix}( Equation 2 ) & \\ M ( n ) = \frac{1}{2} [ L ( n ) + R ( n ) ] & [ 2 ]\end{matrix}$$

In such a case, a monaural signal is determined by mainly the left channel signal, and therefore has an extremely high correlation level with the left channel signal. By contrast with this, the correlation level between the right channel signal and the monaural signal is extremely low, and, consequently, it is extremely difficult to predict the right channel signal from the monaural signal. Therefore, with a configuration for directly predicting the left channel signal and the right channel signal using a monaural signal, there is a problem that the prediction performance for the critical channel signal degrades if the prediction order is a constant in the same way as in Non-Patent Document 1 and Non-Patent Document 2, and if a stereo signal includes a channel signal with extremely low correlation with the monaural signal (hereinafter “critical channel signal”).

It is therefore an object of the present invention to provide a stereo encoding apparatus and stereo encoding method that can perform stereo encoding in the ICP scheme and improve the prediction performance for a critical channel signal even when a stereo signal includes the critical channel signal, and provide a stereo decoding apparatus and stereo decoding method that can provide a decoded signal of high quality using a signal generated and transmitted in this stereo encoding apparatus.

### Means for Solving the Problem

The stereo encoding apparatus of the present invention employs a configuration having: a correlation coefficient calculating section that calculates a first correlation coefficient indicating a correlation level between a monaural signal generated using a stereo signal and a first channel signal of the stereo signal, and calculates a second correlation coefficient indicating a correlation level between the monaural signal and a second channel signal of the stereo signal; a deciding section that, using the first correlation coefficient and the second correlation coefficient, decides whether there is a signal to meet a predetermined condition between the first channel signal and the second channel signal; an inter-channel prediction analyzing section that performs an inter-channel prediction analysis of the first channel signal and the second channel signal to acquire a first inter-channel prediction parameter and a second inter-channel prediction parameter; and an adjusting section that adjusts the first inter-channel prediction parameter and the second inter-channel prediction parameter, using a decision result in the deciding section.

The stereo decoding apparatus of the present invention employs a configuration having: a receiving section that receives a first inter-channel prediction parameter acquired by performing an inter-channel prediction analysis of a first channel signal of a stereo signal, a second inter-channel prediction parameter acquired by performing the inter-channel prediction analysis of a second channel signal of the stereo signal, a monaural encoded signal acquired by encoding a monaural signal generated using the stereo signal, and an order of the first inter-channel prediction parameter, the parameters, the signal and the order being generated in a stereo encoding apparatus; a monaural decoding section that decodes the monaural encoded signal to generate a monaural decoded signal; a first channel decoding section that generates a first channel decoded signal using the first inter-channel prediction parameter, the order of the first inter-channel prediction parameter and the monaural decoded signal; and a second channel decoding section that generates a second channel decoded signal using the second inter-channel prediction parameter, the order of the first inter-channel prediction parameter and the monaural decoded signal.

The stereo encoding method of the present invention employs a configuration having: a correlation coefficient calculating step of calculating a first correlation coefficient indicating a correlation level between a monaural signal generated using a stereo signal and a first channel signal of the stereo signal, and calculating a second correlation coefficient indicating a correlation level between the monaural signal and a second channel signal of the stereo signal; a deciding step of deciding whether there is a signal to meet a predetermined condition between the first channel signal and the second channel signal, using the first correlation coefficient and the second correlation coefficient; an inter-channel prediction analyzing step of performing an inter-channel prediction analysis of the first channel signal and the second channel signal to acquire a first inter-channel prediction parameter and a second inter-channel prediction parameter; and an adjusting step of adjusting the first inter-channel prediction parameter and the second inter-channel prediction parameter, using a decision result in the deciding step.

The stereo decoding method of the present invention employs a configuration having: a receiving step of receiving a first inter-channel prediction parameter acquired by performing an inter-channel prediction analysis of a first channel signal of a stereo signal, a second inter-channel prediction parameter acquired by performing the inter-channel prediction analysis of a second channel signal of the stereo signal, a monaural encoded signal acquired by encoding a monaural signal generated using the stereo signal, and an order of the first inter-channel prediction parameter, the parameters, the signal and the order being generated in a stereo encoding apparatus; a monaural decoding step of decoding the monaural encoded signal to generate a monaural decoded signal; a first channel decoding step of generating a first channel decoded signal using the first inter-channel prediction parameter, the order of the first inter-channel prediction parameter and the monaural decoded signal; and a second channel decoding step of generating a second channel decoded signal using the second inter-channel prediction parameter, the order of the first inter-channel prediction parameter and the monaural decoded signal.

### Advantageous Effects of Invention

According to the present invention, it is possible to perform stereo encoding in the ICP scheme and improve the accuracy of prediction performance for a critical channel signal even when a stereo signal includes the critical channel signal, thereby providing a decoded signal of high quality on the decoding side.

### BRIEF DESCRIPTION OF DRAWINGS

FIG. 1 is a block diagram showing main components of a stereo encoding apparatus according to an embodiment of the present invention;

FIG. 2 is a block diagram showing main components inside an ICP encoding section according to an embodiment of the present invention;

FIG. 3 illustrates the configuration and operations of an adaptive filter forming a left ICP analyzing section or a right ICP analyzing section according to an embodiment of the present invention;

FIG. 4 is a flowchart showing the steps of adaptively adjusting the order of an ICP parameter in an ICP encoding section according to an embodiment of the present invention;

FIG. 5 is a block diagram showing main components of a stereo decoding apparatus according to an embodiment of the present invention;

FIG. 6 illustrates the effect of an embodiment of the present invention; and

FIG. 7 is a flowchart showing the steps of adaptively adjusting the order of an ICP parameter using an adjustment result of a previous frame in an ICP encoding section according to an embodiment of the present invention.

### BEST MODE FOR CARRYING OUT THE INVENTION

An embodiment of the present invention will be explained below in detail with reference to the accompanying drawings.

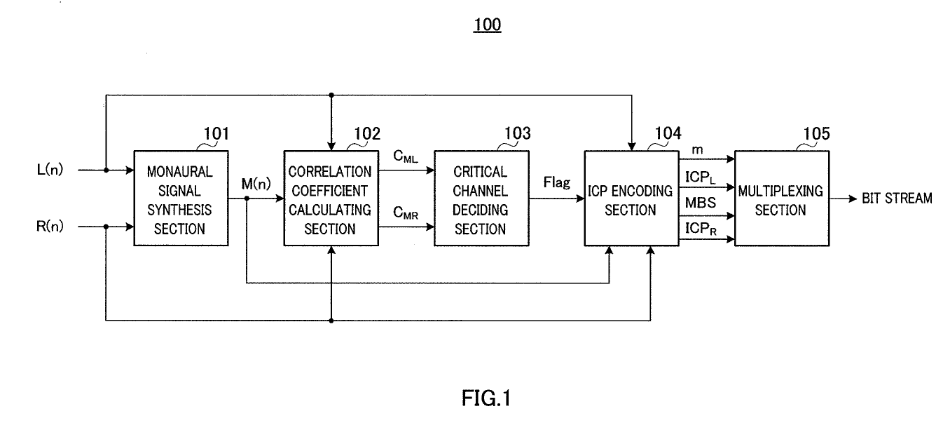

FIG. 1 is a block diagram showing the main components of stereo encoding apparatus 100 according to an embodiment of the present invention. Stereo encoding apparatus 100 receives as input a stereo signal comprised of the left (“L”) channel signal and the right (“R”) channel signal and performs encoding processing on a per frame basis. Further, the descriptions of “left channel,” “right channel,” “L” and “R” are used for ease of explanation and do not necessarily limit the positional conditions of right and left.

Stereo encoding apparatus 100 is provided with monaural signal synthesis section 101, correlation coefficient calculating section 102, critical channel deciding section 103, ICP encoding section 104 and multiplexing section 105. Further, an example case will be explained where a sum of the order of a prediction ICP parameter for a left channel signal and the order of a prediction ICP parameter for a right channel signal is N, the order of the prediction ICP parameter for the left channel is m, and the order of the prediction ICP parameter for the right channel is N-m.

Monaural signal synthesis section 101 generates monaural signal M(n) by synthesis using left channel signal L(n) and right channel signal R(n) according to above equation 2, and outputs the result to correlation coefficient calculating section 102 and ICP encoding section 104. That is, monaural signal synthesis section 101 calculates the monaural signal M(n) by calculating the average value of the left channel signal L(n) and the right channel signal R(n).

Correlation coefficient calculating section 102 calculates correlation coefficient C_{ML} between the monaural signal M(n) and the left channel signal L(n), and correlation coefficient C_{MR} between the monaural signal M(n) and the right channel signal R(n), according to following equation 3 and equation 4, and outputs the results to critical channel deciding section 103. In equation 3 and equation 4, F represents the frame length.

$$\begin{matrix}( Equation 3 ) & \\ {C}_{ML} = \frac{{\sum }_{n = 1}^{F} M ( n ) L ( n )}{\sqrt{{\sum }_{n = 1}^{F} {M ( n )}^{2} {\sum }_{n = 1}^{F} {L ( n )}^{2}}} & [ 3 ] \\ ( Equation 4 ) & \\ {C}_{MR} = \frac{{\sum }_{n = 1}^{F} M ( n ) R ( n )}{\sqrt{{\sum }_{n = 1}^{F} {M ( n )}^{2} {\sum }_{n = 1}^{F} {R ( n )}^{2}}} & [ 4 ]\end{matrix}$$

Critical channel deciding section 103 compares the correlation coefficients C_{ML} and C_{MR} received as input from correlation coefficient calculating section 102, and, when the ratio between C_{ML} and C_{MR} is not within a predetermined range (e.g., between 90 percents and 111 percents), decides the channel signal of the lower correlation with the monaural signal M(n) as a critical channel in the left channel signal L(n) and the right channel signal R(n), sets the value of the flag (“Flag”) to “L” or “R” and outputs the result to ICP encoding section 104. Further, when the ratio between C_{ML} and C_{MR} is within a predetermined range (e.g., between 90 percents and 111 percents), critical channel deciding section 103 decides that there is no critical channel, sets the value of the flag to “0” and outputs the result to ICP encoding section 104.

ICP encoding section 104 encodes the monaural signal M(n) received as input from monaural signal synthesis section 101 to generate the monaural bit stream MBS. Further, if the flag received as input from critical channel deciding section 103 is “0,” ICP encoding section 104 generates the left channel ICP parameter ICP_{L} and the right channel ICP parameter ICP_{R} by setting both orders of prediction ICP parameters for the left channel and right channel to N/2 and performing an ICP analysis. Further, if the flag received as input from critical channel deciding section 103 is “L” or “R,” ICP encoding section 104 generates the left channel ICP parameter ICP_{L} and the right channel ICP parameter ICP_{R} by adaptively adjusting the orders of prediction ICP parameters for the left channel and right channel and performing an ICP analysis. ICP encoding section 104 outputs the monaural bit stream MBS, the left channel ICP parameter ICP_{L}, the right channel ICP parameter ICP_{R} and the order m of the prediction ICP parameter for the left channel to multiplexing section 105. Further, ICP encoding section 104 will be described later in detail.

Multiplexing section 105 multiplexes the monaural bit stream MBS, the left channel ICP parameter ICP_{L}, the right channel ICP parameter ICP_{R} and the order m of the prediction ICP parameter for the left channel, and outputs the resulting bit stream.

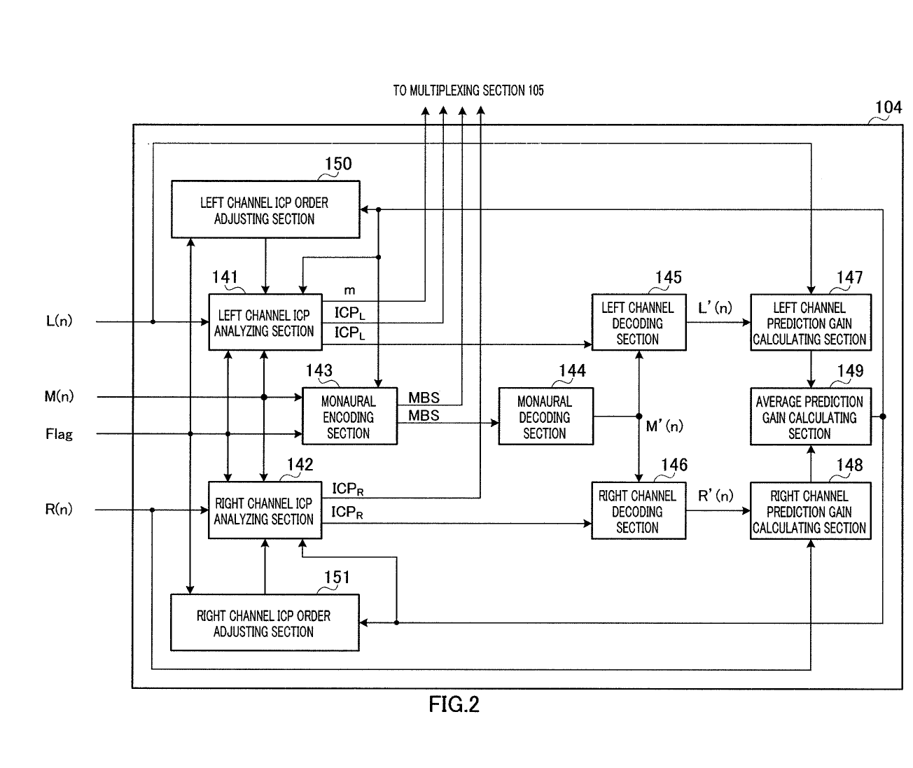

FIG. 2 is a block diagram showing the main components inside ICP encoding section 104.

ICP encoding section 104 is provided with left channel ICP analyzing section 141, right channel ICP analyzing section 142, monaural encoding section 143, monaural decoding section 144, left channel decoding section 145, right channel decoding section 146, left channel prediction gain calculating section 147, right channel prediction gain calculating section 148, average prediction gain calculating section 149, left channel ICP order adjusting section 150 and right channel ICP order adjusting section 151.

Left channel ICP analyzing section 141 is comprised of an adaptive filter, and performs an ICP analysis using the unique correlation between the left channel signal L(n) and the monaural signal M(n), to generate the left channel ICP parameter ICP_{L} of the order m that is received as input from left channel ICP order adjusting section 150. If none of the order m that is received as input from left channel ICP order adjusting section 150, the flag that is received as input from critical channel deciding section 103 and the comparison result that is received as input from average prediction gain calculating section 149 is “0,” left channel ICP analyzing section 141 outputs the generated left channel ICP parameter ICP_{L} to left channel decoding section 145. Further, if the order m that is received as input from left channel ICP order adjusting section 150 is “0,” if the flag that is received as input from critical channel deciding section 103 is “0,” or if the comparison result that is received as input from average prediction gain calculating section 149 is “0,” left channel ICP analyzing section 141 outputs the generated left channel ICP parameter ICP_{L} and the order m at that time, to multiplexing section 105.

Right channel ICP analyzing section 142 is comprised of an adaptive filter, and performs an ICP analysis using the unique correlation between the right channel signal R(n) and the monaural signal M(n), to generate the right channel ICP parameter ICP_{R} of the order (N-m) that is received as input from right channel ICP order adjusting section 151. If the order (N-m) that is received as input from right channel ICP order adjusting section 151 is not N, if the flag that is received as input from critical channel deciding section 103 is not “0,” and if the comparison result that is received as input from average prediction gain calculating section 149 is not “0,” right channel ICP analyzing section 142 outputs the generated right channel ICP parameter ICP_{R} to right channel decoding section 146. Further, if the order (N-m) that is received as input from right channel ICP order adjusting section 151 is N, if the flag that is received as input from critical channel deciding section 103 is “0,” or if the comparison result that is received as input from average prediction gain calculating section 149 is “0,” right channel ICP analyzing section 142 outputs the generated right channel ICP parameter ICP_{R} to multiplexing section 105.

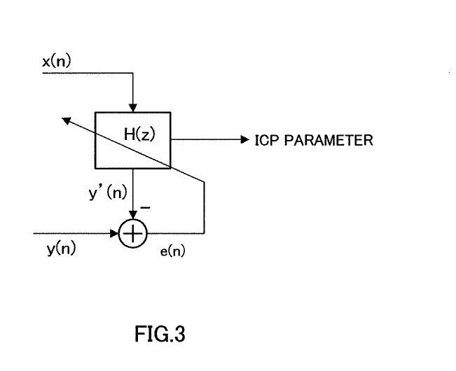

FIG. 3 illustrates the configurations and operations of the adaptive filter forming left channel ICP analyzing section 141 and right channel ICP analyzing section 142. In this figure, H(z) holds H(z)=b₀+b₁(z⁻¹)+b₂(z⁻²)+ . . . +bₖ(z^{-k}), which shows the model (i.e. transfer function) of an adaptive filter such as a FIR (Finite Impulse Response) filter. Here, k represents the order of adaptive filter coefficients, b=[b₀, b₁, . . . , bₖ] represents adaptive filter coefficients (parameters), x(n) represents the input signal of the adaptive filter, y′(n) represents the output signal of the adaptive filter, and y(n) represents the reference signal. In left channel ICP analyzing section 141 and right channel ICP analyzing section 142, x(n) corresponds to the monaural signal M(n), and y(n) corresponds to the left channel signal L(n) in left channel ICP analyzing section 141 and corresponds to the right channel signal R(n) in right channel ICP analyzing section 142.

In the adaptive filter, adaptive filter parameters b=[b₀, b₁, . . . , bₖ] are calculated and outputted according to following equation 5 such that the mean square error between the prediction signal and the reference signal is minimum.

$$\begin{matrix}( Equation 5 ) & \\ \begin{matrix}M S E ( n , b ) = E \{ {[ e ( n ) ]}^{2} \} \\ = E \{ {[ y ( n ) - {y}^{′} ( n ) ]}^{2} \} \\ = E \{ {[ y ( n ) - {\sum }_{i = 0}^{k} {b}_{i} x ( n - i ) ]}^{2} \}\end{matrix} & [ 5 ]\end{matrix}$$

In this equation, E represents a statistical expectation operator and e(n) represents prediction error.

Left channel ICP analyzing section 141 and right channel ICP analyzing section 142 output left channel ICP parameter ICP_{L}=[b^{L}₀, b^{L}₁, . . . , b^{L}ₘ] and right channel ICP parameter ICP_{R}=[b^{R}₀, b^{R}₁, . . . , b^{R}_{(N-m)}], respectively, as the adaptive filter parameter b=[b₀, b₁, . . . , bₖ] to minimize the mean square error between the prediction signal and the reference signal.

Referring back to FIG. 2, monaural encoding section 143 generates the monaural bit stream MBS by performing speech encoding processing such as AMR-WB (Adaptive Multi Rate-WideBand) on the monaural signal M(n) received as input from monaural signal synthesis section 101. If none of the flag that is received as input from critical channel deciding section 103 and the comparison result that is received as input from average prediction gain calculating section 149 is “0,” monaural encoding section 143 outputs the generated monaural bit stream MBS to monaural decoding section 144. If the flag that is received as input from critical channel deciding section 103 is “0” or the comparison result that is received as input from average prediction gain calculating section 149 is “0,” monaural encoding section 143 outputs the generated monaural bit stream MBS to multiplexing section 105.

Monaural decoding section 144 performs speech decoding processing such as AMR-WB using the monaural bit stream MBS received as input from monaural encoding section 143, and outputs the generated monaural reconstruction signal M′(n) to left channel decoding section 145 and right channel decoding section 146.

Left channel decoding section 145 performs decoding processing according to following equation 6 using the monaural reconstruction signal M′(n) received as input from monaural decoding section 144 and the left channel ICP parameter ICP_{L}=[b^{L}₀, b^{L}₁, . . . , b^{L}ₘ] received as input from left channel ICP analyzing section 141, thereby generating the left channel reconstruction signal L′(n) and outputting this to left channel prediction gain calculating section 147.

$$\begin{matrix}( Equation 6 ) & \\ {L}^{′} ( n ) = {\sum }_{i = 1}^{m} {b}_{i}^{L} ( n ) {M}^{′} ( n - i ) & [ 6 ]\end{matrix}$$

Right channel decoding section 146 performs decoding processing according to following equation 7 using the monaural reconstruction signal M′(n) received as input from monaural decoding section 144 and the right channel ICP parameter ICP_{R}=[b^{R}₀, b^{R}₁, . . . , b^{R}_{(N-m)}] received as input from right channel ICP analyzing section 142, thereby generating right channel reconstruction signal R′(n) and outputting this to right channel prediction gain calculating section 148.

$$\begin{matrix}( Equation 7 ) & \\ {R}^{′} ( n ) = {\sum }_{i = 1}^{N - m} {b}_{i}^{R} ( n ) {M}^{′} ( n - i ) & [ 7 ]\end{matrix}$$

Left channel prediction gain calculating section 147 calculates the left channel prediction gain G_{L} according to following equation 8 using the left channel signal L(n) and the left channel reconstruction signal L′(n) received as input from left channel decoding section 145, and outputs the result to average prediction gain calculating section 149.

$$\begin{matrix}( Equation 8 ) & \\ {G}_{L} = 10 {log}_{10} \frac{\sum {L}^{2} ( n )}{\sum {( L ( n ) - {L}^{′} ( n ) )}^{2}} & [ 8 ]\end{matrix}$$

Right channel prediction gain calculating section 148 calculates the right channel prediction gain G_{R} according to following equation 9 using the right channel signal R(n) and the right channel reconstruction signal R′(n) received as input from right channel decoding section 146, and outputs the result to average prediction gain calculating section 149.

$$\begin{matrix}( Equation 9 ) & \\ {G}_{R} = 10 {log}_{10} \frac{\sum {R}^{2} ( n )}{\sum {( R ( n ) - {R}^{′} ( n ) )}^{2}} & [ 9 ]\end{matrix}$$

Average prediction gain calculating section 149 calculates and stores the average value between the left channel prediction gain G_{L} received as input from left channel prediction gain calculating section 147 and the right channel prediction gain G_{R} received as input from right channel prediction gain calculating section 148, as an average prediction gain. Average prediction gain calculating section 149 compares the average prediction gain AG and the stored past average prediction gain AG′, and outputs, to left channel ICP order adjusting section 150 and right channel ICP order adjusting section 151, “1” as the comparison result if AG is higher than AG′ and “0” as the comparison result if AG is equal to or lower than AG′.

If the comparison result received as input from average prediction gain calculating section 149 is “1” and the flag received as input from critical channel deciding section 103 is “L,” left channel ICP order adjusting section 150 increments the order m of the ICP parameter for the left channel by one and then outputs the result to left channel ICP analyzing section 141. Further, if the comparison result received as input from average prediction gain calculating section 149 is “1” and the flag received as input from critical channel deciding section 103 is “R,” left channel ICP order adjusting section 150 decrements the order m of the prediction ICP parameter for the left channel by one and then outputs the result to left channel ICP analyzing section 141. If the comparison result received as input from average prediction gain calculating section 149 is “0,” left channel ICP order adjusting section 150 does not perform any processing.

If the comparison result received as input from average prediction gain calculating section 149 is “1” and the flag received as input from critical channel deciding section 103 is “L,” right channel ICP order adjusting section 151 decrements the order N-m of the prediction ICP parameter for the right channel by one and then outputs the result to right channel ICP analyzing section 142. If the comparison result received as input from average prediction gain calculating section 149 is “1” and the flag received as input from critical channel deciding section 103 is “R,” right channel ICP order adjusting section 151 increments the order N-m of the prediction ICP parameter for the right channel by one and then outputs the result to right channel ICP analyzing section 142. If the comparison result received as input from average prediction gain calculating section 149 is “0,” right channel ICP order adjusting section 151 does not perform any processing.

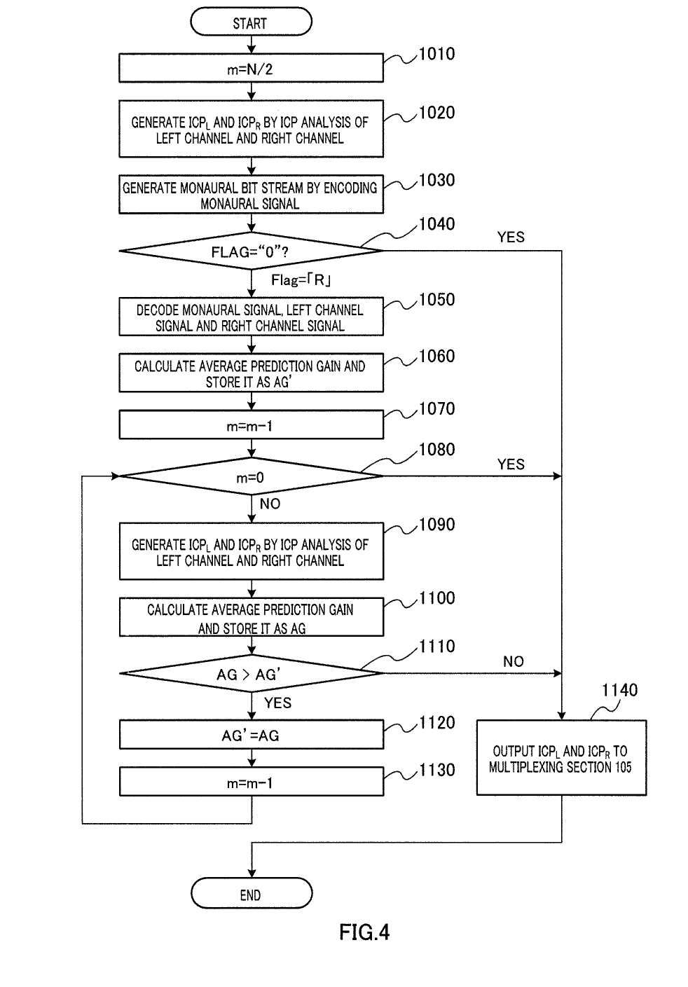

FIG. 4 is a flowchart showing the steps of adaptively adjusting the order of an ICP parameter in ICP encoding section 104. Further, only a case will be explained with FIG. 4, where the critical channel is the right channel, that is, where the flag is “R.”

First, in step (“ST”) 1010, left channel ICP order adjusting section 150 sets the order m of a prediction ICP parameter for the left channel to N/2, and right channel ICP order adjusting section 151 sets the order N-m of a prediction ICP parameter for the right channel to N/2.

Next, in ST 1020, left channel ICP analyzing section 141 and right channel ICP analyzing section 142 generate the left channel ICP parameter ICP_{L} and the right channel ICP parameter ICP_{R} each including elements of order N/2.

Next, in ST 1030, monaural encoding section 143 generates the monaural bit stream MBS by encoding a monaural signal generated in monaural signal synthesis section 101.

Next, in ST 1040, left channel ICP analyzing section 141 and right channel ICP analyzing section 142 decide whether a flag received as input from critical channel deciding section 103 is “0.”

If the flag is decided “0” in ST 1040 (“YES” in ST 1040), in ST 1140, left channel ICP analyzing section 141 and right channel ICP analyzing section 142 output the left channel ICP parameter ICP_{L} and the right channel ICP parameter ICP_{R} to multiplexing section 105.

If the flag is not “0” and is decided, for example, “R” in step ST 1040 (“NO” in ST 1040), in ST 1050, left channel ICP analyzing section 141 and right channel ICP analyzing section 142 output the left channel ICP parameter ICP_{L} and the right channel ICP parameter ICP_{R} to left channel decoding section 145 and right channel decoding section 146, respectively, and left channel decoding section 145 and right channel decoding section 146 decode the left channel signal and the right channel signal, respectively. Further, monaural decoding section 144 decodes the monaural signal using the monaural bit stream MBS received as input from monaural encoding section 143.

Next, in ST 1060, left channel prediction gain calculating section 147 calculates the left channel prediction gain, right channel prediction gain calculating section 148 calculates the right channel prediction gain, and average prediction gain calculating section 149 calculates the average value of the left channel prediction gain and the right channel prediction gain as an average prediction gain and stores it as AG′.

Next, in ST 1070, left channel ICP order adjusting section 150 decrements the order m of the prediction ICP parameter for the left channel by one and right channel ICP order adjusting section 151 increments the order N-m of the prediction ICP parameter for the right channel by one.

Next, in ST 1080, left channel ICP analyzing section 141 decides whether the order m of the prediction ICP parameter for the left channel is “0,” and right channel ICP analyzing section 142 decides whether the order N-m of the prediction ICP parameter for the right channel is N.

If the order m of the ICP parameter for the left channel is decided “0” in ST 1080, that is, if the order N-m of the ICP parameter for the right channel is decided N (“YES” in ST 1080), in ST 1140, left channel ICP analyzing section 141 and right channel ICP analyzing section 142 output the left channel ICP parameter ICP_{L} and the right channel ICP parameter ICP_{R}, respectively, to multiplexing section 105.

If the order m of the ICP parameter for the left channel is not decided “0” in ST 1080, that is, if the order N-m of the ICP parameter for the right channel is not decided N (“NO” in ST 1080), in ST 1090, left channel ICP analyzing section 141 and right channel ICP analyzing section 142 generate the left channel ICP parameter ICP_{L} including elements of the order m and the right channel ICP parameter ICP_{R} including elements of the order N-m.

Next, in ST 1110, left channel decoding section 145 and right channel decoding section 146 decode the left channel signal and the right channel signal, respectively, left channel prediction gain calculating section 147 and right channel prediction gain calculating section 148 calculate a left channel prediction gain and a right channel prediction gain, respectively, and average prediction gain calculating section 149 calculates the average value of the left channel prediction gain and the right channel prediction gain as an average prediction gain and stores it as AG.

Next, in ST 1110, average prediction gain calculating section 149 decides whether AG>AG′.

If AG>AG′ is not true in ST 1110 (“NO” in ST 1110), that is, if the comparison result is “0” in average prediction gain calculating section 149, then the processing proceeds to ST 1140.

If AG>AG′ is true in ST 1110 (“YES” in ST 1110), that is, if the comparison result is “1” in average prediction gain calculating section 149, the average prediction gain calculating section 149 stores AG as AG′ (AG′=AG).

Next, in ST 1130, left channel ICP order adjusting section 150 decrements the order m of the prediction ICP parameter for the left channel by one and right channel ICP order adjusting section 151 increments the order N-m of the prediction ICP parameter for the right channel by one, and the processing returns to ST 1080.

Although a case has been described above with FIG. 4 where the right channel is a critical channel, if the left channel is a critical channel, the processing in ICP encoding section 104 is basically the same as the processing shown in FIG. 4 and yet differs only in ST 1070 and ST 1130. That is, if the left channel is a critical channel, in ST 1070, left channel ICP order adjusting section 150 increments the order m of the prediction ICP parameter for the left channel by one and right channel order adjusting section 151 decrements the order N-m of the prediction ICP parameter for the right channel by one. Further, in ST 1130, left channel ICP order adjusting section 150 increments the order m of the ICP parameter for the left channel by one and right channel order adjusting section 151 decrements the order N-m of the ICP parameter for the right channel by one, and the processing returns to ST 1080.

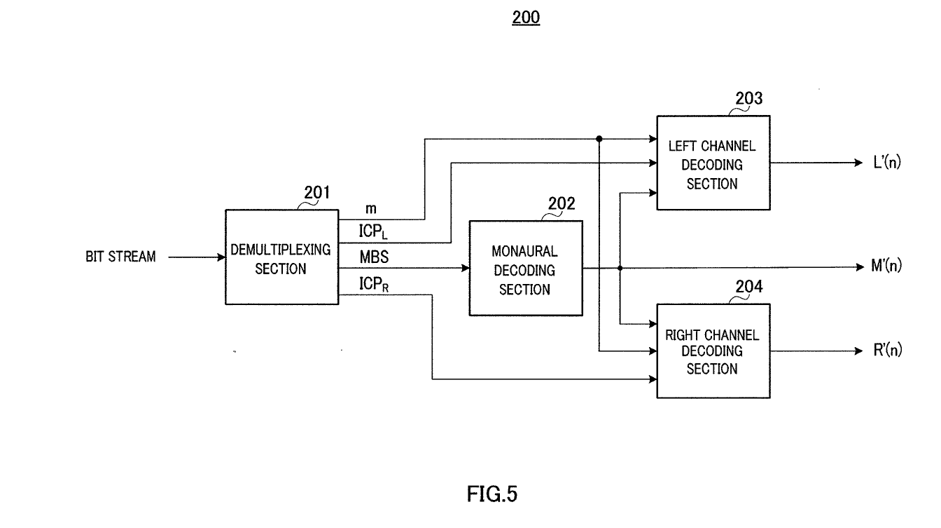

FIG. 5 is a block diagram showing the main components of stereo decoding apparatus 200 according to the present embodiment.

Stereo decoding apparatus 200 is provided with demultiplexing section 201, monaural decoding section 202, left channel decoding section 203 and right channel decoding section 204.

Demultiplexing section 201 demultiplexes the bit stream transmitted from stereo encoding apparatus 100 into the monaural bit stream MBS, the left channel ICP parameter ICP_{L}, the right channel ICP parameter ICP_{R} and the order m of the left channel ICP parameter ICP_{L}, and outputs the monaural bit stream MBS to monaural decoding section 202, the left channel ICP parameter ICP_{L} and the order m of the left channel ICP parameter ICP_{L} to left channel decoding section 203, and the right channel ICP parameter ICP_{R} and the order m of the left channel ICP parameter ICP_{L} to right channel decoding section 204.

Monaural decoding section 202 performs speech decoding processing such as AMR-WB using the monaural bit stream MBS received as input from demultiplexing section 201, outputs the generated monaural reconstruction signal M′(n) to left channel decoding section 203 and right channel decoding section 204, and outputs the signal as a decoded signal.

Left channel decoding section 203 performs decoding according to following equation 6, using the monaural reconstruction signal M′(n) received as input from monaural decoding section 202, the left channel ICP parameter ICP_{L} and its order m received as input from demultiplexing section 201, and outputs the resulting left channel reconstruction signal L′(n) as a decoded signal.

Right channel decoding section 204 performs decoding according to equation 7, using the monaural reconstruction signal M′(n) received as input from monaural decoding section 202 and the right channel ICP parameter ICP_{R} and the order m of the left channel ICP parameter ICP_{L} received as input from demultiplexing section 201, and outputs the resulting right channel reconstruction signal R′(n) as a decoded signal.

Thus, according to the present embodiment, the stereo encoding apparatus decides a critical channel, and decreases the order of an ICP parameter for a non-critical channel and increases the order of a prediction ICP parameter for a critical channel by the decrease such that an ICP prediction gain is maximum, thereby maintaining the amount of coding information and improving the accuracy of coding in stereo encoding. Further, by decoding an encoded signal (i.e. bit stream) in which the accuracy of coding is improved as described above, it is possible to produce a decoded signal of high quality. If this decoded signal is a decoded speech signal, it is possible to obtain decoded speech of good quality with little distortion.

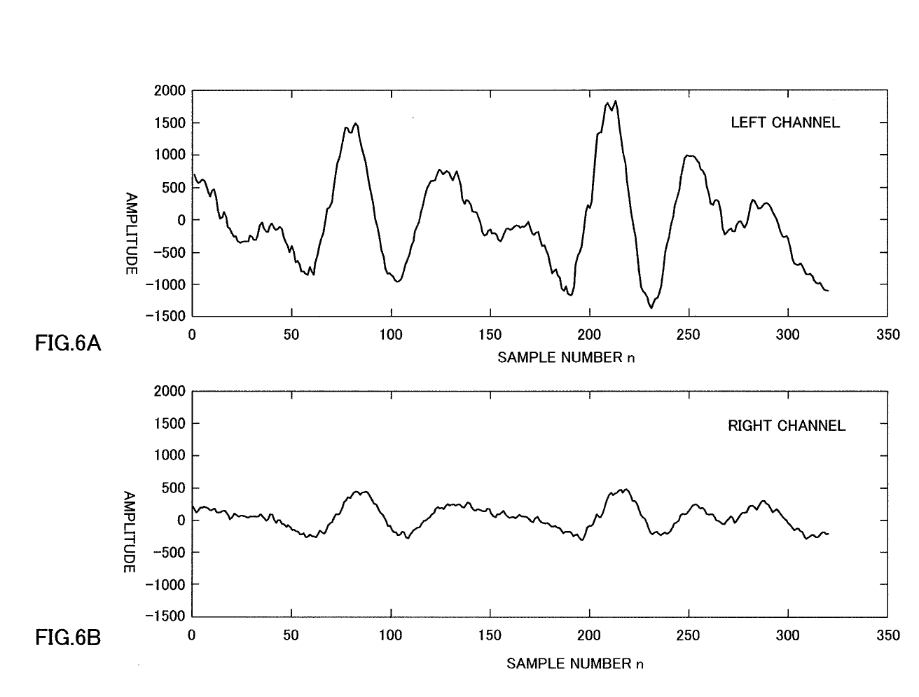

FIG. 6A and FIG. 6B illustrate the effect of the present embodiment. FIG. 6A shows amplitude values of the left channel signal L(n) over one frame, and FIG. 6B illustrate amplitude values of the right channel signal R(n) over one frame. Further, in FIG. 6A and FIG. 6B, the horizontal axis shows sample numbers n in one frame, and the vertical axis shows amplitude. If the monaural signal M(n) is calculated according to equation 2 using the left channel signal L(n) and right channel signal R(n) shown in FIG. 6A and FIG. 6B, the correlation C_{ML} between M(n) and L(n) is 0.98774, and the correlation C_{MR} between M(n) and R(n) is 0.82894. Here, the ratio of C_{ML} to C_{MR} is 84 percents, and therefore the right channel signal R(n) is decided as a critical channel. If ICP encoding is performed after setting both the order of the left channel ICP parameter ICP_{L} and the order of the right channel ICP parameter ICP_{R} to three, the left channel prediction gain and the right channel prediction gain are 18.45 dB and 7.365 dB, respectively, and the average prediction gain is 12.9 dB. By contrast with this, if ICP encoding is performed after adjusting the orders of ICP parameters using the stereo encoding method according to the present embodiment and setting the order of the left channel ICP parameter ICP_{L} to two and the order of the right channel parameter ICP_{R} to four, the left channel prediction gain and the right channel prediction gain are 18.11 dB and 8.178 dB, respectively, and the average prediction gain is 13.14 dB. That is, with the present example where a critical channel is provided, according to the present embodiment, it is possible to improve the average prediction gain by 0.24 dB.

Further, although an example case has been described above with the present embodiment where a critical channel decision is made to adaptively adjust the orders of ICP parameters, it is equally possible to make a critical channel decision and adjust the number of quantization bits of ICP parameters. To be more specific, the number of quantization bits of an ICP parameter for a non-critical channel is decreased, the number of quantization bits of an ICP parameter for a critical channel is increased by the decrease, and quantization of the ICP parameters for both channels are performed with the adjusted bits, using arbitrary methods such as scalar quantization and vector quantization.

Further, although an example case has been described above with the present embodiment where, in ICP encoding section 104, left channel ICP order adjusting section 150 and right channel ICP order adjusting section 151 adjust the ICP orders using an average prediction gain acquired from the left channel prediction gain and the right channel prediction gain, instead of the prediction gain, it is equally possible to use the correlation value between the left channel signal L(n) and the left channel reconstruction signal (i.e. prediction signal) L′(n) and the correlation value between the right channel signal R(n) and the right channel reconstruction signal (i.e. prediction signal) R′(n), and adjust the ICP orders and the number of quantization bits of ICP parameters using, for example, the average value of those correlation values.

Further, although an example case has been described above with the present embodiment where an ICP analysis is directly performed for the left channel signal and the right channel signal to adaptively adjust the orders of ICP parameters, it is equally possible to perform an ICP analysis of excitation signals of the left channel signal and right channel signal to adjust the orders of ICP parameters. Here, an excitation signal refers to an excitation signal acquired by, for example, CELP encoding.

Further, although an example case has been described above with the present embodiment where the average value of the left channel signal L(n) and the right channel signal R(n) is calculated to generate the monaural signal M(n), it is equally possible to use other methods of synthesizing a monaural signal, and M=w₁L+w₂R is one example of equation. In this equation, w₁ and w₂ are weighting coefficients to fulfill the relationship w₁+w₂=1.0

Further, although an example case has been described above with the present embodiment where the orders of ICP parameters for both channels are adaptively adjusted according to the steps shown in FIG. 4, if the sum of the orders of ICP parameters for both channels is very low and equal to or less than a predetermined value, it is equally possible to calculate the average prediction gains in possible combinations of the orders of ICP parameters for both channels and find the combination in which the average prediction gain is maximum.

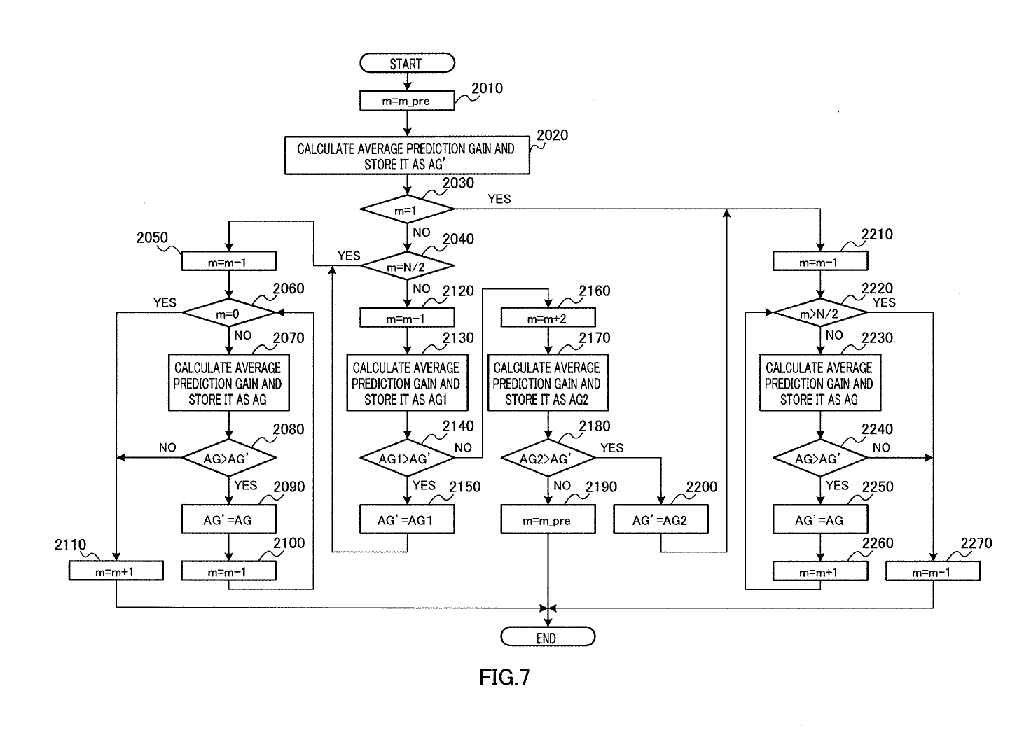

Further, although an example case has been described above with the present embodiment where the orders of ICP parameters for both channels are initialized to N/2 and adaptively adjusted according to the steps shown in FIG. 4, it is equally possible to initialize the orders of ICP parameters for both channels using the adjustment result in stereo encoding in the previous frame and adaptively adjust the orders of the ICP parameters for the current frame according to the steps shown in FIG. 7. A case is possible where the correlation level between channels in each frame is similar between adjacent frames, and, in this case, the optimal ICP parameter order is also similar between the adjacent frames. Consequently, the order in the current frame is adjusted by setting the order acquired from the adjustment result in the previous frame as the initial value and increasing or decreasing the initial value order, thereby decreasing the number of loops required to adjust the orders of ICP parameters and decreasing the amount of calculations. The processing in loops shown in FIG. 7 is basically the same as the processing in loops shown in FIG. 4, and the differences between the steps shown in FIG. 7 and the steps shown in FIG. 4 will be explained. Further, an example case will be described with this figure, where the R channel is a critical signal, that is, where a flag is “R.” First, ICP encoding section 104 initialize m using the order m_pre of the left channel parameter ICP_{L} in the previous frame (in ST 2010). Next, when m initialized using m_pre is “1” (“YES” in ST 2030), m is incremented by one within the range of N/2 while the orders of ICP parameters are adjusted to maximize the average prediction gain (in ST 2210 to 2270). Further, if m initialized using m_pre is not “1” but is N/2 (“YES” in ST 2040), m is decremented by one while the ICP parameters are adjusted to maximize the average prediction gain (in ST 2050 to ST 2110). Further, if m initialized using m_pre is not “1” nor N/2 (“NO” in ST 2040), based on a changing condition of an average prediction gain by one increment or one decrement, the flow proceeds to the loop in ST 2060 to ST 2110 or the loop in ST 2210 to ST 2270 (in ST 2120 to ST 2220), or the ICP adjustment result in the pervious frame is used as the adjustment result as is, that is, without changing m initialized using m_pre (in ST 2190).

Further, if the flag is “L,” in FIG. 7, it is required to reverse the relationship between increment and decrement of order m and perform operations using the opposite decision criterion in ST 2220 (i.e. “m<N/2”).

Further, if both channels are not a critical signal, that is, if the flag indicates “0,” the relationship m=N/2 holds.

An embodiment of the present invention has been explained above.

Further, according to the present embodiment, in FIG. 4 and FIG. 7, it is possible to rearrange and execute rearrangeable steps, or it is possible to execute the steps concurrently (e.g., ST 1020 and ST 1030).

Further, although a case has been described above with the present embodiment where critical channel deciding section 103 decides whether there is a critical channel using the ratio of the correlation coefficient C_{ML} between the left channel signal and a monaural signal to the correlation coefficient C_{MR} between the right channel signal and the monaural signal, it is equally possible to make the decision using a different index whereby it is possible to decide the correlation between each channel signal and the monaural signal.

Further, although a case has been described above with the present embodiment where stereo decoding apparatus 200 decodes a bit stream transmitted from stereo encoding apparatus 100, the present invention is not limited to this, and it is needless to say that it is possible to receive and decode a bit stream that is not transmitted from stereo encoding apparatus 100 as long as the bit stream is encoded data that can be decoded by a decodable a scheme in stereo decoding apparatus 200.

Further, the stereo encoding apparatus, stereo decoding apparatus and stereo encoding and decoding methods of the present invention can be implemented with various changes.

Further, although an example case has been described above with the present embodiment where speech signals are encoding targets, the stereo encoding apparatus, stereo decoding apparatus and stereo encoding and decoding methods of the present invention are applicable to audio signals in addition to speech signals.

The stereo encoding apparatus and stereo decoding apparatus according to the present invention can be mounted on a communication terminal apparatus and base station apparatus in a mobile communication system, so that it is possible to provide a communication terminal apparatus, base station apparatus and mobile communication system having the same operational effect as described above.

Although a case has been described above with the above embodiments as an example where the present invention is implemented with hardware, the present invention can be implemented with software. For example, by describing the stereo encoding method and stereo decoding method according to the present invention in a programming language, storing this program in a memory and making the information processing section execute this program, it is possible to implement the same function as the stereo encoding apparatus and stereo decoding apparatus according to the present invention.

Furthermore, each function block employed in the description of each of the aforementioned embodiments may typically be implemented as an LSI constituted by an integrated circuit. These may be individual chips or partially or totally contained on a single chip.

“LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells in an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2007-016550, filed on Jan. 26, 2007, including the specification, drawings and abstract, is incorporated herein by reference in its entirety.

### INDUSTRIAL APPLICABILITY

The stereo encoding apparatus, stereo decoding apparatus and stereo encoding and decoding methods according to the present invention are suitable for mobile telephones, IP telephones, television conference, and so on.

1. A stereo encoding apparatus comprising:
a correlation coefficient calculating section that calculates a first correlation coefficient indicating a correlation level between a monaural signal generated using a stereo signal and a first channel signal of the stereo signal, and calculates a second correlation coefficient indicating a correlation level between the monaural signal and a second channel signal of the stereo signal;
a deciding section that, using the first correlation coefficient and the second correlation coefficient, decides whether there is a signal to meet a predetermined condition between the first channel signal and the second channel signal;
an inter-channel prediction analyzing section that performs an inter-channel prediction analysis of the first channel signal and the second channel signal to acquire a first inter-channel prediction parameter and a second inter-channel prediction parameter; and
an adjusting section that adjusts the first inter-channel prediction parameter and the second inter-channel prediction parameter, using a decision result in the deciding section.

2. The stereo encoding apparatus according to claim 1, wherein the deciding section makes a decision using a ratio between the first correlation coefficient and the second correlation coefficient.

3. The stereo encoding apparatus according to claim 2, wherein the deciding section decides that there is the signal to meet the predetermined condition and that a signal having a lower correlation level with the monaural signal between the first channel signal and the second channel signal is the signal to meet the predetermined condition when the ratio is not within a predetermined range, and decides that there is no signal to meet the predetermined condition when the ratio is within the predetermined range.

4. The stereo encoding apparatus according to claim 3, wherein the adjusting section adjusts an order of the first inter-channel prediction parameter and an order of the second inter-channel prediction parameter such that a sum of the order of the first inter-channel prediction parameter and the order of the second inter-channel prediction parameter is a constant.

5. The stereo encoding apparatus according to claim 4, wherein the adjusting section sets the order of the first inter-channel prediction parameter and the order of the second inter-channel prediction parameter equal when the decision result shows that there is no signal to meet the predetermined condition, and sets an order of an inter-channel prediction parameter associated with the signal to meet the predetermined condition higher between the order of the first inter-channel prediction parameter and the order of the second inter-channel prediction parameter when the decision result shows that there is the signal to meet the predetermined condition.

6. The stereo encoding apparatus according to claim 5, further comprising:
a first prediction gain calculating section that calculates a first prediction gain indicating a prediction performance of an inter-channel prediction of the first channel using the first inter-channel prediction parameter; and
a second prediction gain calculating section that calculates a second prediction gain indicating a prediction performance of an inter-channel prediction of the second channel using the second inter-channel prediction parameter,
wherein, when the decision result shows that there is the signal to meet the predetermined condition, the adjusting section adjusts the order of the first inter-channel prediction parameter and the order of the second inter-channel prediction parameter such that an average value of the first prediction gain and the second prediction gain is maximum.

7. The stereo encoding apparatus according to claim 6, wherein, when the decision result shows that there is the signal to meet the predetermined condition, the adjusting section equally initializes the order of the first inter-channel prediction parameter and the order of the second inter-channel prediction parameter, and, between the order of the first inter-channel prediction parameter and the order of the second inter-channel prediction parameter, increments an order of an inter-channel prediction parameter associated with the signal to meet the predetermined condition one by one and decrements the other order one by one.

8. The stereo encoding apparatus according to claim 6, wherein, when the decision result shows that there is the signal to meet the predetermined condition, between the order of the first inter-channel prediction parameter and the order of the second inter-channel prediction parameter in a current frame, the adjusting section increments one order one by one and decrements the other order one by one or decrements one order one by one and increments the other order one by one based on an initial value, the initial value being an adjustment result of the order of the first inter-channel prediction parameter and the order of the second inter-channel prediction parameter in a previous frame.

9. A stereo decoding apparatus comprising:
a receiving section that receives a first inter-channel prediction parameter acquired by performing an inter-channel prediction analysis of a first channel signal of a stereo signal, a second inter-channel prediction parameter acquired by performing the inter-channel prediction analysis of a second channel signal of the stereo signal, a monaural encoded signal acquired by encoding a monaural signal generated using the stereo signal, and an order of the first inter-channel prediction parameter, the parameters, the signal and the order being generated in a stereo encoding apparatus;
a monaural decoding section that decodes the monaural encoded signal to generate a monaural decoded signal;
a first channel decoding section that generates a first channel decoded signal using the first inter-channel prediction parameter, the order of the first inter-channel prediction parameter and the monaural decoded signal; and
a second channel decoding section that generates a second channel decoded signal using the second inter-channel prediction parameter, the order of the first inter-channel prediction parameter and the monaural decoded signal.

10. A stereo encoding method comprising:
a correlation coefficient calculating step of calculating a first correlation coefficient indicating a correlation level between a monaural signal generated using a stereo signal and a first channel signal of the stereo signal, and calculating a second correlation coefficient indicating a correlation level between the monaural signal and a second channel signal of the stereo signal;
a deciding step of deciding whether there is a signal to meet a predetermined condition between the first channel signal and the second channel signal, using the first correlation coefficient and the second correlation coefficient;
an inter-channel prediction analyzing step of performing an inter-channel prediction analyzing of the first channel signal and the second channel signal to acquire a first inter-channel prediction parameter and a second inter-channel prediction parameter; and
an adjusting step of adjusting the first inter-channel prediction parameter and the second inter-channel prediction parameter, using a decision result in the deciding step.

11. A stereo decoding method comprising:
a receiving step of receiving a first inter-channel prediction parameter acquired by performing an inter-channel prediction analysis of a first channel signal of a stereo signal, a second inter-channel prediction parameter acquired by performing the inter-channel prediction analysis of a second channel signal of the stereo signal, a monaural encoded signal acquired by encoding a monaural signal generated using the stereo signal, and an order of the first inter-channel prediction parameter, the parameters, the signal and the order being generated in a stereo encoding apparatus;
a monaural decoding step of decoding the monaural encoded signal to generate a monaural decoded signal;
a first channel decoding step of generating a first channel decoded signal using the first inter-channel prediction parameter, the order of the first inter-channel prediction parameter and the monaural decoded signal; and
a second channel decoding step of generating a second channel decoded signal using the second inter-channel prediction parameter, the order of the first inter-channel prediction parameter and the monaural decoded signal.
